(19) United States
(12) Patent Application Publication
(10) Pub. No.: US 2024/0386134 A1
(43) Pub. Date: Nov. 21, 2024

(54) System and Method for Maintaining the Security and Confidentiality of Consumer Information

(71) Applicant: Rapsag-Arrac Inc., Wilmington, DE (US)

(72) Inventors: Aimeelene GASPAR, San Francisco, CA (US); Andrew CARRA, San Francisco, CA (US)

(73) Assignee: Rapsag-Arrac Inc., Wilmington, DE (US)

(21) Appl. No.: 18/543,928

(22) Filed: Dec. 18, 2023

Related U.S. Application Data
(63) Continuation of application No. 16/281,880, filed on Feb. 21, 2019, now abandoned.
(60) Provisional application No. 62/633,385, filed on Feb. 21, 2018.

(51) Int. Cl. G06F 21/62; G06F 21/60; H04L 9/32

(52) U.S. Cl. CPC G06F 21/6245; G06F 21/602; G06F 21/629; H04L 9/3236

(57) ABSTRACT

Systems and methods for maintaining the security and confidentiality of personally identifiable information are disclosed. Information owners may register with a service provider, which may obtain and store non-personally identifiable information associated with the information owner. Information consumers may request information associated with an information owner, and the service provider may facilitate access to the requested information based on permissions defined by the information owner.

### CROSS REFERENCE TO RELATED APPLICATIONS

This application is a continuation of U.S. application Ser. No. 16/281,880, filed Feb. 21, 2019, which was concurrently filed as International Application Number PCT/US2019/018981, filed Feb. 21, 2019, which applications claim priority benefit to U.S. Application No. 62/633,385, filed Feb. 21, 2018, each of which are incorporated by reference in their entireties.

### FIELD

The present patent document relates generally to systems and methods for maintaining the security and confidentiality of consumer information. In particular, the systems and methods disclosed herein allow consumers to engage in the exchange of information, such as financial information, while providing consumers with the assurance that they will maintain control over the sharing of their personally identifiable information.

### BACKGROUND

Presently, individual consumers face difficulties in obtaining products and services that suit their needs. The financial industry is an example of one in which such difficulties are prevalent. Difficulties arise, in part, due to industry marketing practices that have made the processes of comparing, selecting, and applying for products unnecessarily invasive and complicated, to the point that such processes are impractical for the average consumer. Further difficulties arise when consumers take on the complicated task of managing information that may be required by the institutions that provide the products and services that consumers seek. Often, consumers may not understand their full range of options with respect to certain products or services, or whether they qualify to receive such products or services.

In addition, maintaining the security of consumer information has presented a widespread problem across multiple industries. Millions of consumers have had their identity information stolen. Factors contributing to the problem include the fact that many transactions require consumers to share highly sensitive data via non-secure means, such as personal email. Consumers often share information, such as personal account information, on an all-or-nothing basis, without any means of discretely selecting specific data points to be shared. Moreover, consumers often share the same sensitive information multiple times for different purposes, via multiple websites with multiple logins and passwords.

Whereas individual consumers are the rightful owners of their sensitive information, third-party institutions, such as bureaus, financial institutions, and marketing/lead-generation agencies often become de facto custodians of such sensitive information. The goals of such institutions are not well aligned with individual consumers' best interests. For example, such institutions may use consumers' sensitive information in ways that conflict with consumers' best interests. In addition, institutions and other third parties may not possess the means to ensure that consumer information is kept secure and used only for consumers' intended purposes, and institutions and other third parties are susceptible to security breaches in which consumers' sensitive information may be compromised. Thus, the price of obtaining various products and services includes not only a consumer's sensitive information itself, but also the risk that the security of that sensitive information may be compromised.

The aforementioned problems are exemplified in the difficulties and risks that arise when consumers consider switching between retail finance products. Those difficulties and risks have resulted in diminished competition between banks, which still benefit from consumers' deposits and purchases, despite the fact that retail finance products no longer yield significant returns. Credit bureaus have complete access to consumer information, yet those bureaus take few precautions to protect consumers from the consequences of such access. In fact, credit bureaus have leveraged the lack of protection in order to sell additional products to consumers. Consumers' sensitive information is often shared for purposes of financial product marketing, without the consumers' knowledge or permissions. Credit worthiness is predicated on the unnecessary use of revolving credit.

Despite recent advances in communication and computation technologies, modern institutions, including financial institutions, as well as their services and products remain largely unchanged. Institutional understanding and uptake of new technologies has lagged behind, and institutions have worked against the adoption of new technologies. Retail financial products are difficult to understand, difficult to shop for and compare, and difficult to switch as markets and consumer needs evolve. Consumers are required, unnecessarily, to share sensitive information in the process of shopping for products or services, or engaging in other transactions, including many retail financial and credit transactions.

### SUMMARY

Systems and methods are disclosed for maintaining the security and confidentiality of consumer information. An embodiment enables individual consumers to take control of their personal information, and to explicitly approve and manage what information is being shared, and with whom. An embodiment allows individual consumers to publish only the necessary elements of their data to obtain products and services that suit their needs, and to receive recommended options according to the real-time evaluation of their data.

In addressing the aforementioned problems, an embodiment may incorporate the use of a global network and varied means of immediate access to data; the existence and wide availability of strong, asymmetric cryptography; the ability to organize and partition consumer data in a manner that the consumer can control in the instant; an increased access to all types of data, including financial data, via APIs and information aggregation services; and the rise of mechanical identity and information verification services.

An embodiment allows for marketplaces to be structured in ways that operate based on consumer interests and intentional permissioning of discrete data elements. In accordance with an embodiment, when a consumer wishes to accomplish a financial goal, the embodiment can provide the consumer with options, recommend courses of action, and obtain binding quotes, without sharing the consumer's sensitive information. Once a consumer has selected a product offered by a vendor, the systems and methods described herein can simplify the processes of applying for and realizing the product by supplying verified, mechanically updated information to only the selected vendor. An embodiment extends to any transaction that requires identity verification, credit scoring, or other tasks involving verified structured data. In accordance with an embodiment, control and approval over which information is shared with whom, and the ability to compare and select products, rest in the hands of the individual consumer.

An embodiment may process and compile information, such as financial information, on behalf of consumers without coupling that information with personally identifying information. An embodiment allows consumers to uniquely permission access to personally identifiable information and other information needed to obtain products and services.

An embodiment allows consumers to discretely share personally identifiable information and non-personally identifiable information based on explicitly defined permissions, without storing personally identifiable information that is coupled with non-personally identifiable information within a single data store. Examples of such data stores include device stores, which may store personally identifiable information, and networked stores, which may store non-personally identifiable information. Accordingly, an embodiment eliminates the risk of compromising the personally identifiable information should the non-personally identifiable information data store become compromised.

In accordance with an embodiment, a service provider generates secure signatures for organized assemblies of verified personally identifiable information and stores the signatures in a permissioned server-side store for identity verification, which allows authenticated access for verification of personally identifiable information elements shared securely between parties.

An embodiment is capable of partitioning personally identifiable information from non-personally identifiable information, such as financial information, thus providing consumers with exclusive control of identity data, while a service provider stores, maintains, and updates information, such as financial information, on the consumers' behalf. Accordingly, an embodiment limits the potential consequences of a server-side security breach, while automating aggregation and convenient access of financial information, for example. Without identity information, financial information cannot be used for identity theft or transactions. In accordance with an embodiment, personally identifiable is further partitioned into discrete units suitable for sharing to complete specific transactions while minimizing risk.

An embodiment provides for the secure sharing of consumer information with other parties, both individuals and institutions, via mobile-to-mobile device communications or through a direct integration via API with any application, such as a mobile or web-based application. Strong, end-to-end encryption is facilitated by consumers' personal devices. In accordance with an embodiment, a distributed party-to-party network is used to transmit identity data, while centralized systems maintain up-to-date records and verify data to prevent impersonation.

In accordance with an embodiment, individual consumers have full control over what information they share, either directly in the case of personally identifiable information, or as ongoing, revocable grants in the case of other information, such as financial information. In accordance with an embodiment, third-party access to individual consumer data is not allowed without the consumer first reviewing an access grant request and indicating whether access should be allowed. Consumer identity information is not transmitted without the consumer being notified and authorizing transmission. Upon an institution, for example, requesting access to consumer information, the consumer is presented with a clear list of permissions and a proposed duration for access that the consumer can approve or deny.

An embodiment allows consumers to shop by sharing financial data without sharing personally identifiable information or contact information. Accordingly, the embodiment provides proof of impartiality and uniform standards for financial service and product providers, while maximizing privacy and minimizing annoyance for consumers.

In accordance with an embodiment, a combination of industry-leading vendors verify identity information and manage financial information on behalf of consumers. Information may be verified, for example, by credit reporting agencies, financial institutions, or the IRS. In accordance with an embodiment, these capabilities, in combination with information partitioning, ensures the accuracy of identity information and the correctness of financial information, while minimizing the risk inherent in the combination of such information.

In accordance with an embodiment, a method includes the steps of performing an identification of an information owner; storing one or more hash signatures that can be used to subsequently verify the identity of the information owner, without storing personally identifiable information associated with the information owner; and providing verification of the identity of the information owner to an information consumer, based on permission defined by the information owner.

The method may include the step of storing non-personally identifiable information associated with the information owner. The method may further include the step of providing the non-personally identifiable information to an information consumer, and may provide the information based on permissions defined by the information owner. The method may also include the step of verifying the non-personally identifiable information associated with the information owner. The method may include the step of updating the non-personally identifiable information associated with the information owner, and may further include the step of establishing a secure communication session between the information owner and the information consumer.

In accordance with an embodiment, a method includes the steps of receiving an indication from an information owner that the information owner has approved a grant request from an information consumer; receiving, from the information consumer, a request to verify the identity of the information owner; and verifying the identity of the information owner based on one or more hash signatures associated with the information owner.

The method may include the steps of receiving, from the information consumer, a request for non-personally identifiable information associated with the information owner; and providing, to the information consumer, non-personally identifiable information associated with the information owner, based on permissions defined by the information owner.

In accordance with an embodiment, a method includes the steps of indicating, to a service provider, an intent to request access to information associated with an information owner; receiving a key from the service provider; requesting, from the information owner, access to information associated with the information owner; and upon approval of the request by the information owner, receiving information associated with the information owner. Information associated with the information owner may be non-personally identifiable information, received from the service provider. Information associated with the information owner may be personally identifiable information, received from the information owner.

Each of the methods described herein may be carried out by software running on the devices and computer systems of the information owner, the information consumer, and the service provider.

In accordance with an embodiment, a system includes a service provider configured to facilitate direct communication between an information owner user device and an information consumer computer system. The service provider may be configured to allow the information consumer computer system to access personally identifiable information and non-personally identifiable information associated with the information owner user device based on permissions defined by the information owner user device. According to an embodiment, the service provider does not store personally identifiable information associated with the information owner user device. According to an embodiment, the system may further include the information owner user device. According to an embodiment, the system may further include the information consumer computer system.

The service provider may be configured to identify blocks of personally identifiable information associated with the information owner user device via one or more hash signatures. The service provider may be configured to communicate with an external computer system to verify information associated with the information owner user device. The service provider may be configured to communicate with an external computer system to update information associated with the information owner user device. Said permissions may identify one or more specific blocks of information to be accessed, and said permissions may identify a duration for which each block of information may be accessed.

In accordance with an embodiment, a computer-readable medium may have instructions stored thereon that, when executed, cause a computer to perform the steps of receiving an indication of an intent to request access to information; issuing a key in response to the intent to request access to information; receiving an indication that a request for access to information has been approved; receiving an indication of permissions associated with requested information; and facilitating access to the requested information based on said permissions. The requested information may include non-personally identifiable information that is stored locally by the computer, and the requested information may include personally identifiable information that is not stored locally by the computer.

In accordance with an embodiment, a computer-readable medium may have instructions stored thereon that, when executed, cause a computer to perform the steps of receiving a request for access to information; sending, in response to the request, personally identifiable information; and sending, in response to the request, permission to access non-personally identifiable information. The personally identifiable information may be stored locally by the computer, and the non-personally identifiable information may not be stored locally by the computer.

In accordance with an embodiment, a computer software application includes software configured to receive an indication from an information owner that the information owner has approved a grant request from an information consumer, software configured to receive from the information consumer a request to verify the identity of the information owner, and software configured to verify the identity of the information owner based on one or more hash signatures associated with the information owner. The computer software application may further include software that is configured to receive from the information consumer a request for non-personally identifiable information associated with the information owner, and to provide to the information consumer non-personally identifiable information associated with the information owner, based on permissions defined by the information owner.

In accordance with an embodiment, a computer software application includes software configured to indicate to a service provider an intent to request access to information associated with an information owner, software configured to receive a key from the service provider, software configured to request from the information owner access to information associated with the information owner, and software configured to receive information associated with the information owner upon approval of the request by the information owner. The information associated with the information owner that the software is configured to receive may be non-personally identifiable information, and the software may be configured to receive the information from the service provider. The information associated with the information owner that the software is configured to receive may be personally identifiable information, and the software may be configured to receive the information from the information owner.

### BRIEF DESCRIPTION OF THE DRAWINGS

The accompanying drawings, which are included as part of the present specification, illustrate the presently preferred embodiments and, together with the general description given above and the detailed description given below, serve to explain and teach the principles of the systems and methods described herein.

FIG. 1 shows an overview of a system and various components thereof in accordance with embodiments of the invention.

FIG. 2 shows a high level data model in accordance with one or more embodiments of the invention.

FIG. 3 shows a high level data model in accordance with one or more embodiments of the invention.

FIGS. 4A-4C show a registration diagram in accordance with one or more embodiments of the invention.

FIG. 5 shows a grant request diagram in accordance with one or more embodiments of the invention.

FIG. 6 shows an account aggregation diagram in accordance with one or more embodiments of the invention.

FIG. 7 shows a financial data use diagram in accordance with one or more embodiments of the invention.

The figures are only intended to facilitate the description of the various embodiments described herein. The figures do not describe every aspect of the teachings disclosed herein and do not limit the scope of the claims.

### DETAILED DESCRIPTION

The following description is presented to enable any person skilled in the art to create and use systems and methods for maintaining the security and confidentiality of consumer information that allows consumers to engage in the exchange of information with third parties, while maintaining the privacy of personally identifiable information.

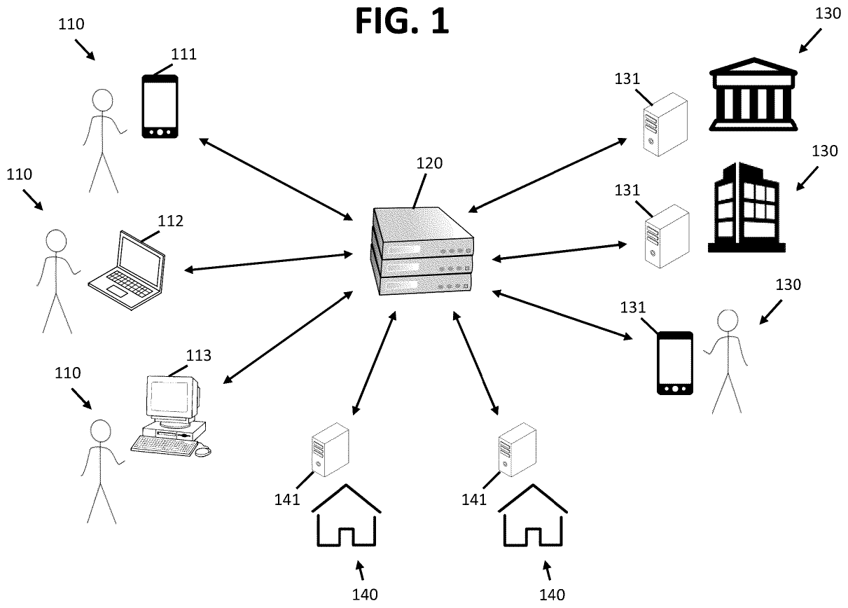

FIG. 1 shows an overview of a system capable of connecting information owners 110, a service provider 120, information consumers 130, and external third party partners 140, in accordance with an embodiment.

The term “information owners” refers to owners of information, including personally identifying information (“PII”) and non-personally identifying information (“non-PII”). Information owners 110 may include, for example, individual people who are consumers of products and services (as described herein) and who maintain an interest in preserving the privacy of their personally identifiable information. Information owners 110 may further include user devices used by such consumers that allow for the storage and processing of information, and for communication with the service provider 120 and information consumers 130. Such user devices may include mobile devices 111 such as cellular phones, tablets, personal data assistants, laptop computers 112, and desktop computers 113, and the like. Mobile devices 111 may include operating system software such as iOS, Android, or other operating system software. Laptop computers 112, and desktop computers 113 may include operating system software such as Windows, Linux, Mac OS, or other operating system software.

The term “information consumers” refers to third parties that request information associated with information owners 110. Information consumers 130 may include, for example, financial institutions, as well as other corporations or individuals, that offer products and services to information owners 110. Information consumers 130 may include, for example, small business owners or even private individuals, such as landlords or estate managers, who are also registered as information owners on the system. Such information consumers 130 may further include devices used by such third parties, such as computer systems 131, having hardware and software configured to store and process information, and to communicate with the service provider 120 and information owners 110. In an embodiment, information consumer computer systems 131 may include user devices such as mobile devices, laptop computers, desktop computers, and the like.

The service provider 120 acts as an intermediary between information owners 110 and information consumers 130, may establish secure connections that allow information to be exchanged between information owners 110 and information consumers 130. The service provider 120 may also include devices used by such intermediaries, such as computer hardware and software configured to store and process information, and to communicate with information owners 110 and information consumers 130. In an embodiment, the service provider 120 includes one or more servers. The service provider 120 may also facilitate direct communication between information owners 110 and information consumers 130 via a secure messaging system.

The service provider 120 allows for personally identifiable information to be discretely shared, separate from other information that is uniquely associated with an information owner 110. An information owner 110 maintains all of its personally identifiable information on its user device. Personally identifiable information is not stored by the service provider 120. The service provider 120 can identify an information owner 110 through the service provider's own internal identifier, which may be stored in the form of a unique signature, or a set of unique signatures for each modular block of personally identifiable information, that is computed based on information provided by an information owner 110 and verified by the service provider 120 on behalf of the information owner 110.

The service provider 120 may allow information consumers 130 to access discrete data sets based on permissions (which may be in the form of access grants) that are determined by information owners 110. Such discrete data sets may include both non-personally identifiable information and the hash signatures for provided personally identifiable information. Permissions are defined by which data is shared, whom the data is shared with, and how long the sharing takes place. At times, data associated with an information owner 110 and stored by the service provider 120 may need to be updated. In such instances, the information owner 110 may use a unique private key to prove its identity to the service provider 120, and may also use the signature of the unique information previously provided to the service provider 120 by the information owner 110.

In accordance with an embodiment, messages sent by the service provider 120 to information owner user devices are sent securely via a designated software application, such as a mobile app. The service provider 120 does not share email addresses or phone numbers associated with information owners 110. The service provider 120 typically does not send email messages to information owners 110 with links to click. In some instances, the service provider 120 may send text messages or SMS messages directly to information owner user devices. In those instances the text messages or SMS messages are typically sent without links to click.

The service provider 120 may further communicate with the computer systems 141 of one or more external third party partners 140 for purposes that include verifying identification and obtaining credit reports and financial information.

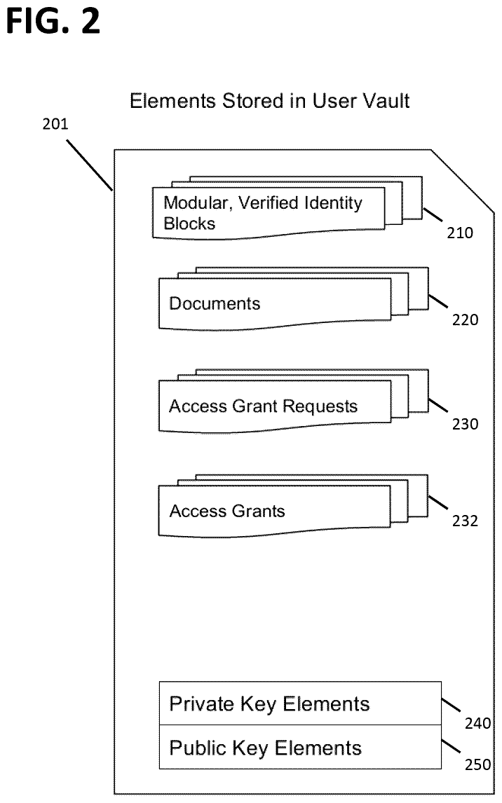

Turning to FIG. 2, illustrated therein is a high level data model in the form of a vault file 201, in accordance with an embodiment. The vault file 201 shown in FIG. 2 includes one or more data files, is associated with a particular information owner 110, and may be stored locally on an information owner user device. Depending on user preferences, a vault file 201 may be stored remotely to a secured (permission-checked) account, such as a Google Drive, iCloud, or other network-accessible account, associated with the information owner 110. The vault file 201 is typically an encrypted file, and a strong password is typically required to unlock information stored in the vault file 201. In some instances, biometric information may be required to unlock information stored in the vault file 201. In some instances, multiple forms of information may be required to unlock information stored in the vault file 201.

Elements stored in the vault file 201 may include modular, verified identity blocks 210, documents 220, access grant requests 230, access grants 232, private key elements 240, and public key elements 250.

Modular, verified identity blocks 210 may include identity information associated with an information owner 110. Such information may include first, middle, and last names, name history, and gender. Identity information may further include numeric identity components associated with an information owner 110, such as ID and social security numbers; current address as verified by a government-issued ID; address history, including dates and former and current residence(s), put in matching case with abbreviations expanded as verified by credit bureaus; and contact information including phone numbers and email addresses. The vault file 201 may also include hash signatures associated with each of the verified identity blocks 210. As described below, hash signatures may be generated by the service provider 120 during identification verification and stored by the service provider 120.

Documents 220 stored in the vault file 201 may include financial documents, including, for example, documents reflecting account information or credit information associated with an information owner 110.

Access grant requests 230 are configured by information consumers 130 and are stored in the vault file 201 as described in further detail below. Access grants 232 may include access grants previously given by the information owner 110. Private key elements 240 and public key elements 250 facilitate the secure exchange of information. Private key elements 240 may include the private halves of public/private key pairs, including identity keys, session establishment keys, and session keys. Public key elements 250 may include the public halves of public/private key pairs, as well as the public keys of other information owners 110 or information consumers 130. The combination of private key elements 240 and public key elements 250 stored in the vault file 201 may depend on the type of encryption used.

Encrypted information stored in a vault file 201 may be re-encrypted with a new key, provided the original key is provided. If access to a vault file 201 is lost, or a password has been compromised, the service provider may script notification of the appropriate institutions, and require the information owner 110 to re-verify its identity, establishing new keys and a new vault file 201.

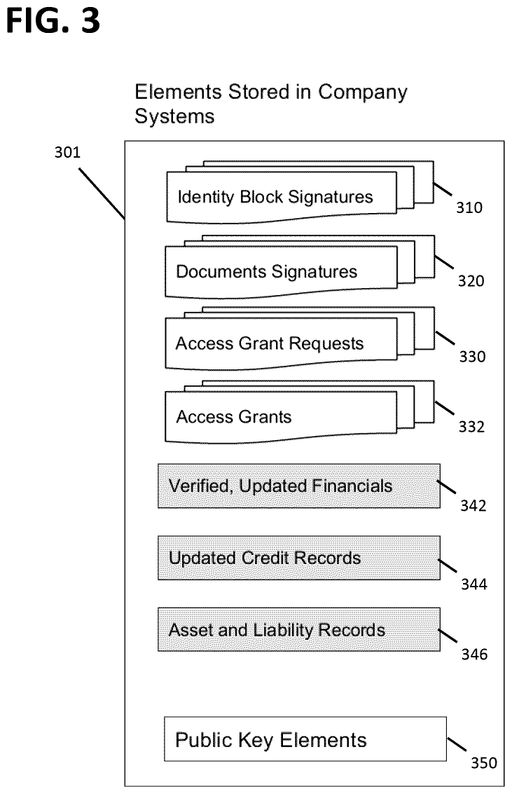

Turning to FIG. 3, illustrated therein is a high level data model that includes elements that may be stored by the service provider 120 in a memory location 301 that corresponds to a particular information owner 110, in accordance with an embodiment.

Elements stored by the service provider 120 may include identity block signatures 310, document signatures 320, access grant requests 330, access grants 332, verified updated financial information 342, updated credit records 344, asset and liability records 346, and public key elements 350.

The service provider 120 may collect information from an information owner 110, and may use that information to establish relationships with third parties, such as financial institutions and credit bureaus, and to perform initial identification verification. Identity block signatures 310 may be one-way hash signatures that can be used to verify discrete blocks of an information owner's personally identifiable information. Once the service provider 120 has verified an information owner's personally identifiable information, the service provider 120 establishes additional secrets that prevent the use of a shared or compromised signature from being used to work back to determine the original data. The service provider 120 may, for example, inject noise or entropy data into blocks of personally identifiable information prior to generating unique signatures to prevent personally identifiable information from being obtained from a compromised signature. After the service provider 120 has established hash signatures and reporting relationships with external third party partners 140, the service provider 120 discards and securely destroys all locally stored identity and address information associated with the corresponding information owner 110, maintaining only the hash signatures. The service provider 120 places contact information (e.g., phone number and email address) associated with the information owner 110 into a secure communications oracle, which precludes the service provider 120 from reading or otherwise accessing the contact information, but allows the service provider 120 to utilize the contact information when communication with the information owner 110 is required.

Access grant requests 330 may include access grant requests previously sent by the information consumer 130. Access grants 332 may be used to facilitate and control sharing of information between information owners 110 and information consumers 130 as described in further detail below.

Verified, updated financial information 342, updated credit reports 344, and asset and liability reports 346 are stored by the service provider 120 and correspond with a particular information owner 110, but do not contain personally identifiable information associated with the information owner 110.

Private key elements 240 may be generated by an information owner 110 and are not stored by the service provider 120. Public key elements 250, 350 may be generated by an information owner 110 or by the service provider 120 and are stored by the service provider 120. Public key elements 250, 350 are used by the service provider 120 to communicate with the information owners 110, and can be used by others, such as information consumers 130, to establish secure communications with information owners 110. The service provider 120 may act as a broker for public key elements 250 based on user requests.

In an embodiment, one-way hashing for password storage is performed using a self-salting, versioned, adaptive complexity cipher such as BCrypt. Remote information verification hashes may be performed using a strong, repeatable hash such as SHA-512. Long and short-lived asymmetric user-to-user and user-to-server identity and communications key pairs are generated using cryptographically strong agreement and signature ciphers such as Elliptic Curve Diffie-Hellman (EDCH) and Elliptic Curve Signature Algorithm (ECDSA). Communications between information owners 110, information consumers 130, and the service provider 120 may utilize forward secrecy such as Double Ratchet. Local storage security for users may be accomplished via a strong symmetric-cipher encrypted database, using a cipher such as AES-CBC.

On an ongoing basis, the service provider 120 may collect information associated with information owners 110 for purposes of updating information stored by the service provider 120. For example, the service provider 120 may collect updated balance, holding, and transaction information from financial networks. If information collected by the service provider 120 does not appear to agree, for example, if new transaction information appears inconsistent with previously established transaction patterns, the service provider 120 may alert the corresponding information owner 110. Information stored by the service provider 120 can be viewed by the corresponding information owner 110 at any time upon provision of the appropriate credentials by the information owner 110. The service provider 120 can perform reconciliation of any stored information and identify patterns without any action from an information owner 110. However, the service provider 120 only knows the information owner 110 as an authorized login and a unique (non-identifying) ID generated by the service provider 120.

Information consumers 130 may request information, such as a credit report, financial information, or personally identifiable information associated with a particular information owner 110. In such instances, the service provider 120 will send a notification to the information owner 110 in the form of a grant request that enumerates the requested information elements or modules, and the information owner 110 can specify which information stored by the service provider 120 should be shared with the information consumer 130.

The service provider 120 may keep information up to date on behalf of an information owner 110, without action from the information owner 110, but the service provider 120 does not store personally identifying information. Access to information stored by the service provider 120 requires registration with the service provider 120.

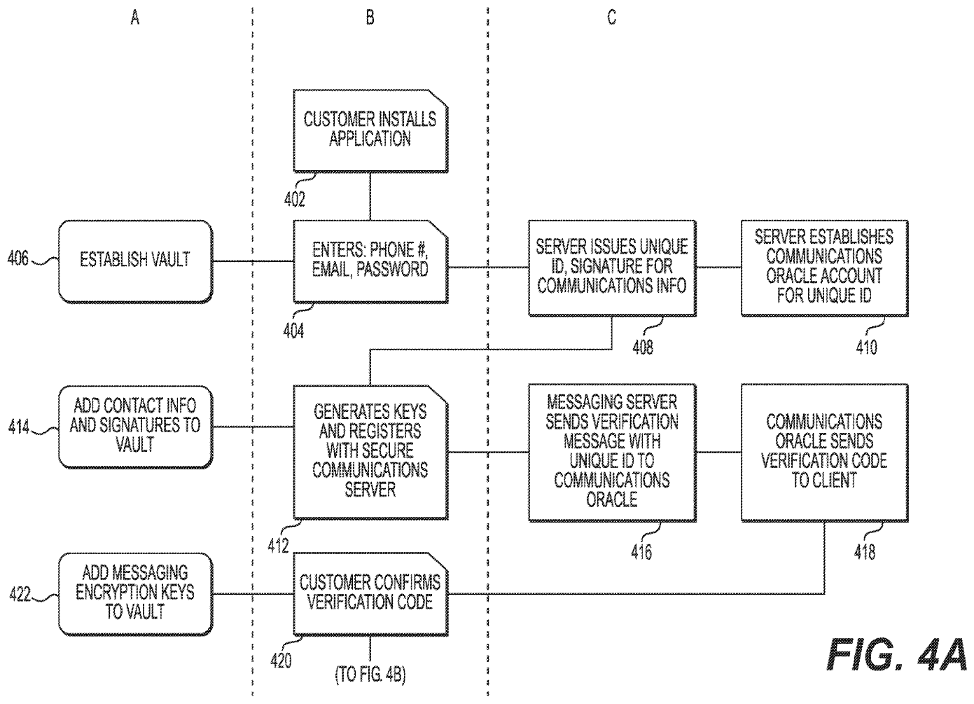

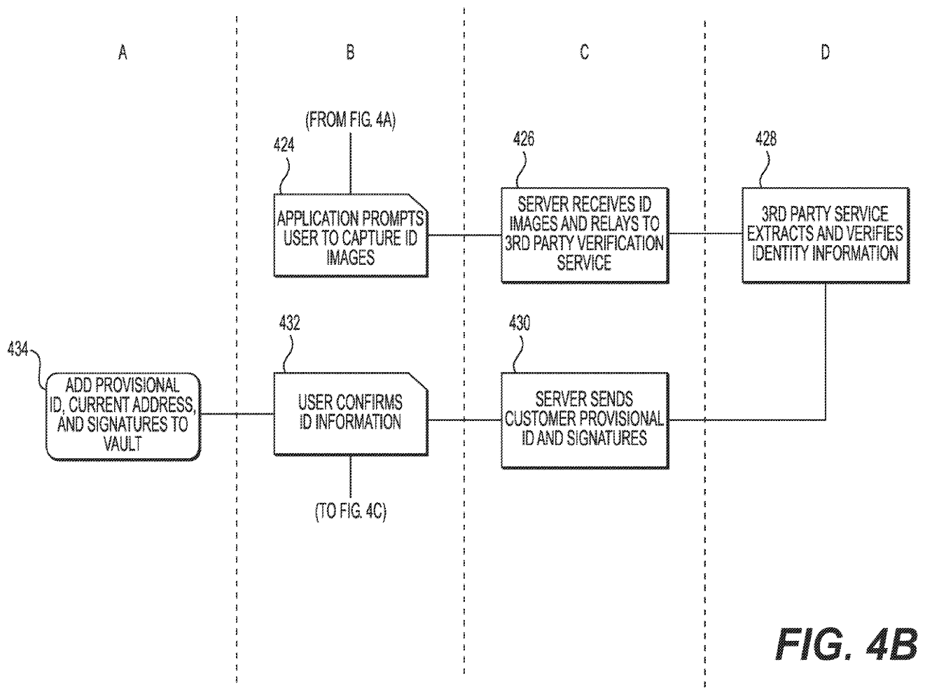

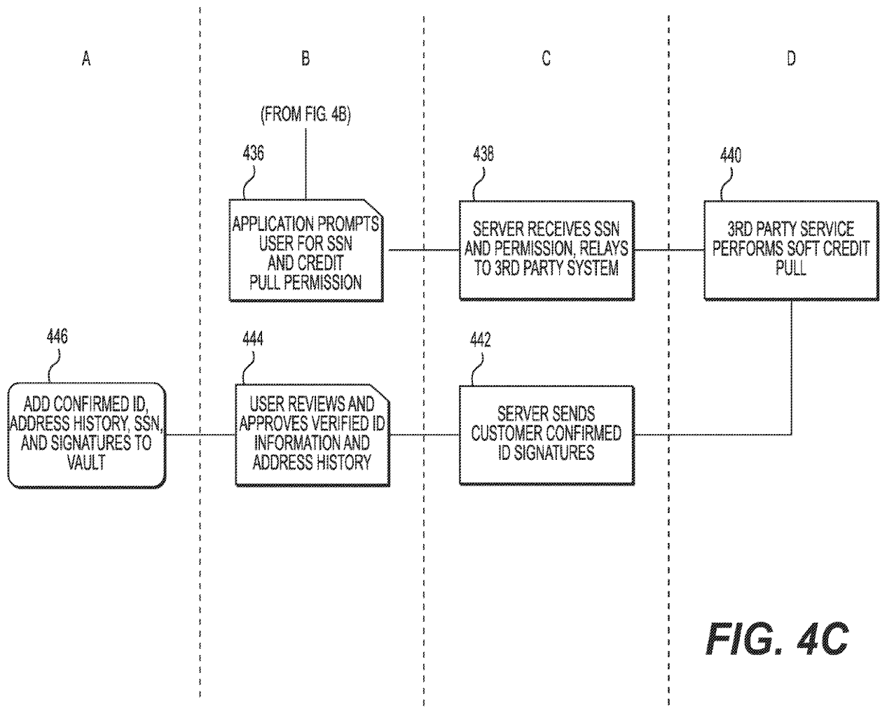

FIGS. 4A-4C show a registration diagram in accordance with one or more embodiments. Illustrated in FIG. 4A is a first phase of an information owner registration process in accordance with an embodiment. With reference to FIG. 4A, column A represents steps primarily associated with a vault file 210 stored on an information owner user device. Column B represents steps primarily associated with a client software application that runs on the information owner user device. The software application may be, for example, a mobile app. Alternatively, the software application may be a standalone desktop application. Column C represents steps primarily associated with the service provider 120.

At step 402, a software application is installed on an information owner user device. The application is used to establish an account with the service provider 120. At step 404, contact information and a secret from the information owner 110 are entered into the application. The contact information may include a phone number and email address associated with the information owner 110. The contact information and secret are sent from the information owner 110 to the service provider 120. The information owner 110 may also request one or more public/private key pairs from the service provider 120. At step 406, a password protected vault file 201 is created and stored on the information owner user device.

At step 408, upon receiving the hashed contact information and secret from the information owner 110, the service provider 120 creates a unique ID, such as a UUID, for the information owner 110 and creates a contact signature for the information owner 110. At step 408, the service provider 120 establishes a communications oracle account, which is tied to the unique ID. The unique ID and information owner credentials are stored in the communications oracle account.

At step 412, The unique ID, the contact signature, and session information are sent to the client software application on the information owner user device. One or more key pairs, including a public key and a private key, are generated by the client software application on the information owner user device and the public elements of these pairs are sent to the service provider 120. The public keys are stored by the service provider 120 for use in establishing secure communications with the information owner 110. At step 414, the unique ID, public and private keys, and contact signature, along with information owner contact information, are stored by the information owner 110 in the vault file 201.

At step 416, a messaging server at the service provider 120 sends a verification message with the unique ID to the communications oracle. At step 418, the communications oracle sends a verification code to the information owner 110. At step 420, the information owner 110 confirms the verification code, and at step 422, messaging and encryption keys are stored to the vault file 201.

Illustrated in FIG. 4B is a second phase of an information owner registration process in accordance with an embodiment. With reference to FIG. 4B, column A represents steps primarily associated with the vault file 210 stored on the information owner user device. Column B represents steps primarily associated with the client software application that runs on the information owner user device. Column C represents steps primarily associated with the service provider 120. Column D represents steps primarily associated with an external third party partner 140.

At step 424, the application collects identification information from the information owner 110. Such collection of identification information may include, for example, capturing images of a government-issued ID, which may include information such as a date of birth, address, or social security number associated with an information owner 110. At step 426, the service provider 120 receives the identification information from the information owner 110, and relays the identification information to the external third party partner 140 for verification purposes.

At step 428, the external third party partner 140 extracts the identification information. If the external third party partner 140 successfully verifies the identification information, it sends an ID confirmation to the service provider 120. Upon receipt of the ID confirmation, the service provider 120 creates and stores an ID signature, and may cache the identification information for purposes of performing a credit pull. At step 430, the service provider 120 sends provisional identification information and signatures to the information owner 110. At step 432, the information owner 110 confirms the provisional identification information. At step 434, the information owner 110 stores the provisional identification information, current address, and signatures to the vault file 201.

Illustrated in FIG. 4C is a third phase of an information owner registration process in accordance with an embodiment. With reference to FIG. 4C, column A represents steps primarily associated with the vault file 210 stored on the information owner user device. Column B represents steps primarily associated with the client software application that runs on the information owner user device. Column C represents steps primarily associated with the service provider 120. Column D represents steps primarily associated with an external third party partner 140.

At step 436, the application may collect information, such as a social security number associated with the information owner 110. The application also requests consent to perform a data synchronization, such as a soft credit pull, on behalf of the information owner 110 on an ongoing basis. At step 438, the service provider 120 may receive information, such as a social security number, along with the consent to perform a data synchronization. The service provider 120 stores the consent from the information owner 110, and uses the information (e.g., social security number) to request a data synchronization from an external third party partner 140. In an embodiment, the service provider 120 receives an ongoing consent from the information owner 110, in which case the service provider 120 may request data synchronizations from the external third party partner 140 on a periodic basis. At step 440, the external third party partner 140 receives the information and request from the service provider 120, confirms the information, generates a credit report, and sends the confirmation and credit report to the service provider 120. The external third party partner 140 that generates a credit report may be the same as, or may be different from, the external third party partner 140 that verifies identification information at step 428, for example. Upon receipt of the credit report, the service provider 120 may store the credit report, excluding any personally identifiable information associated with the information owner 110. The service provider 120 may send the credit report to the information owner 110 for review and confirmation of the credit report.

At step 442, upon receipt of confirmation from the information owner 110, the service provider 120 creates one or more ID signatures, which are sent to the information owner 110. ID signatures may include, for example, address, address history, driver's license number, state ID number, or social security number signatures. At step 444, the information owner 110 receives and approves verified identification information and address history. At step 446, information including the verified identification information, address history, social security number, and signatures are stored to the vault file 201. All personally identifiable information received by the service provider 120 during the information owner registration process is permanently and irrevocably destroyed. The service provider 120 stores only the hash signatures associated with the identity information of the information owner 110.

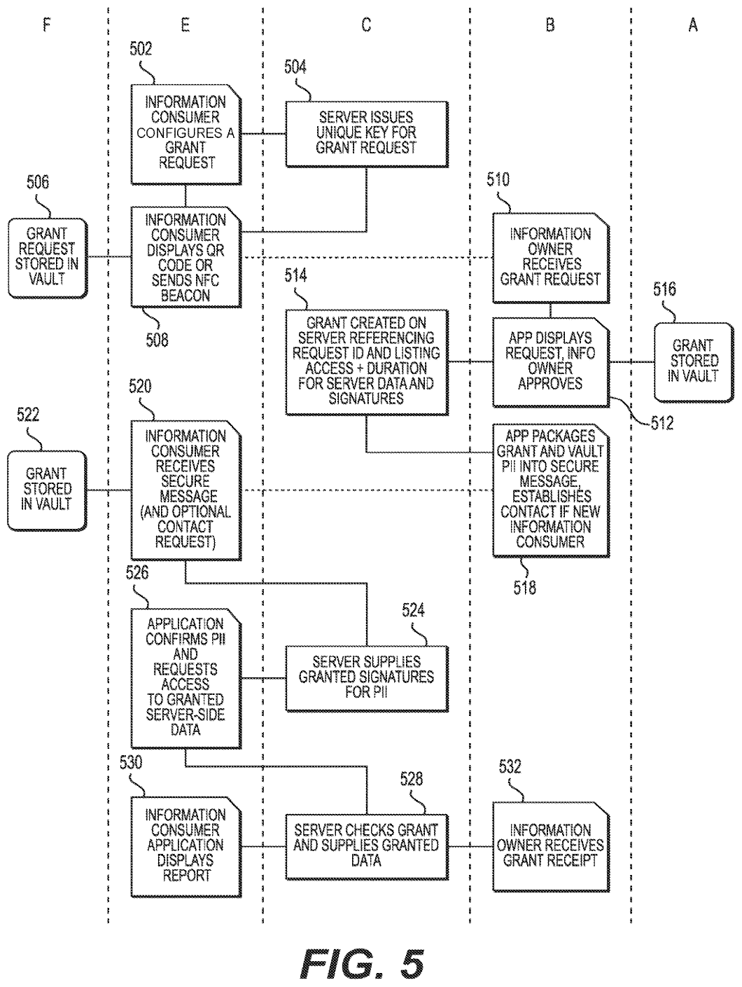

Illustrated in FIG. 5 is a diagram of a grant request process in accordance with an embodiment. With reference to FIG. 5, column A represents steps primarily associated with the vault file 210 stored on an information owner user device. Column B represents steps primarily associated with the client software application that runs on the information owner user device. Column C represents steps primarily associated with the service provider 120. Column E represents steps primarily associated with a client software application that runs on an information consumer user device. Column F represents steps primarily associated with a vault file stored on an information consumer user device or on host computer systems on the information consumer's infrastructure.

At step 502, an information consumer 130 configures a grant request, i.e., a request to access certain information associated with an information owner 110. The grant request may request personally identifiable information elements, non-personally identifiable information elements, or a mixture of the two. The information consumer 130 indicates to the service provider 120 an intent to send the grant request to the information owner 110. Preferably, the information consumer 130 is configured to send successive grant requests, first for non-personally identifiable information only and, subsequently, for personally identifiable information. At step 504, the service provider 120 issues a unique key for the grant request to the information consumer 130. At step 506, the information consumer 130 stores the grant request in an information consumer vault file. At step 508, the information consumer 130 may display a QR (quick response) code or send an NFC (near-field communication) beacon associated with the grant request.

At step 510, the information owner 110 receives the grant request by, for example, scanning the QR code or receiving the NFC beacon. At step 512, the grant request is displayed on the information owner user device. The service provider 120 may present the information owner 110 with the identity of the information consumer 130. The information owner 110 may confirm the identity of the information consumer 130, and the information owner 110 may approve the grant request. Upon approval, the service provider 120 may facilitate the initiation of a secure session between the information consumer 130 and the information owner 110. Upon approval, the information owner 110 may (with or without additional information from the service provider 120) initiate a secure session with the information consumer 130 if not already initiated.

At step 514, a grant is created and stored at the service provider 210, the grant including a reference to a grant request ID, and identifying information to be accessed and the duration of access for server data and signatures. At step 516, the information owner 110 stores the grant in the information owner vault file.

At step 518, the information owner 110 packages the grant and personally identifiable information from the information owner user vault file into a secure message, establishes contact with the information consumer 130, and sends the secure message to the information consumer 130. The information owner 110 may transmit the grant over the secure session.

At step 520, the information consumer 130 receives and decrypts the secure message, including the grant, from the information owner 110. The information consumer 130 may also receive a contact request from the information owner 110 over the secure session. At step 522, the information consumer 130 stores the grant in an information consumer vault file.

At step 524, upon proof that the information consumer 130 has received the grant, via commencement of redemption of the grant by the information consumer's software over a secure connection, the service provider 120 supplies the information consumer 130 with signatures associated with the personally identifiable information that the information owner 110 has sent to the information consumer 130. At step 526, the information consumer 130 confirms the personally identified information and requests access to non-personally identifiable information at the service provider 120 to which the information owner 110 has granted access.

At step 528, the service provider 120 provides the information consumer 130 with information in accordance with permissions defined by the information owner 110. At step 530, the information consumer 130 may display a report or otherwise employ verified data based on the information it receives from the service provider 120. At step 532, the information owner 110 may receive a receipt from the service provider 120 over the secure session, indicating that the information consumer 130 has accessed the requested information. In an embodiment, the information owner 110 may only receive a receipt on the first time the information consumer 130 accesses the requested information.

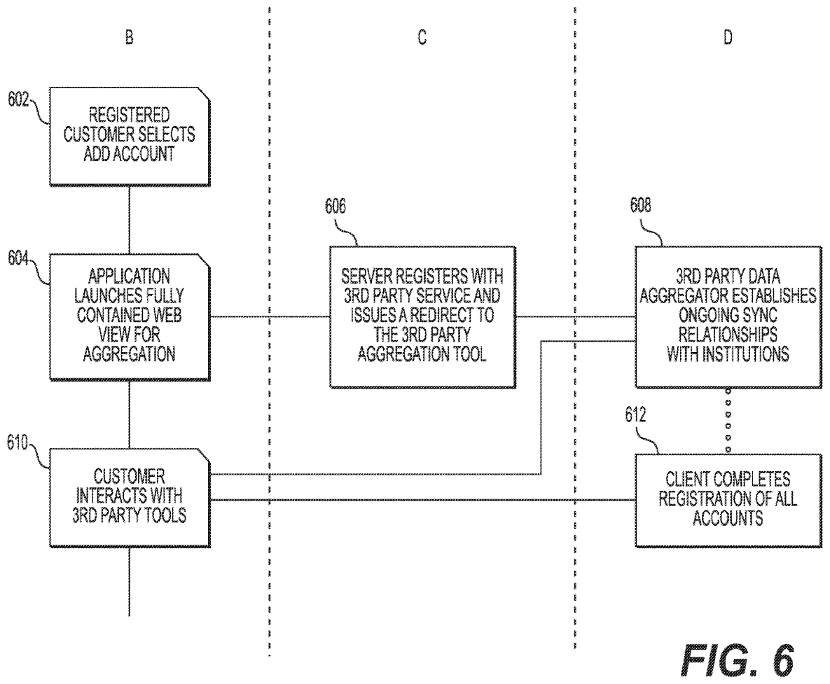

Illustrated in FIG. 6 is a diagram of an account aggregation process in accordance with an embodiment. With reference to FIG. 6, column B represents steps primarily associated with the client software application that runs on the information owner user device. Column C represents steps primarily associated with the service provider 120. Column D represents steps primarily associated with an external third party partner 140. Account aggregation may be performed at any time following the account registration process illustrated in FIGS. 4A-4C.

At step 602, a registered information owner 110 generates a request for account aggregation. At step 604, the application on the information owner user device launches a fully contained web view for aggregation. At step 606, the service provider 120 registers with an external third party partner 140 and issues a redirect to and aggregation tool associated with the external third party partner 140. At step 608, the external third party partner 140 establishes ongoing sync relationships with institutions. At step 610, the information owner 110 interacts with third party aggregation tools. At step 612, registration of all accounts is completed.

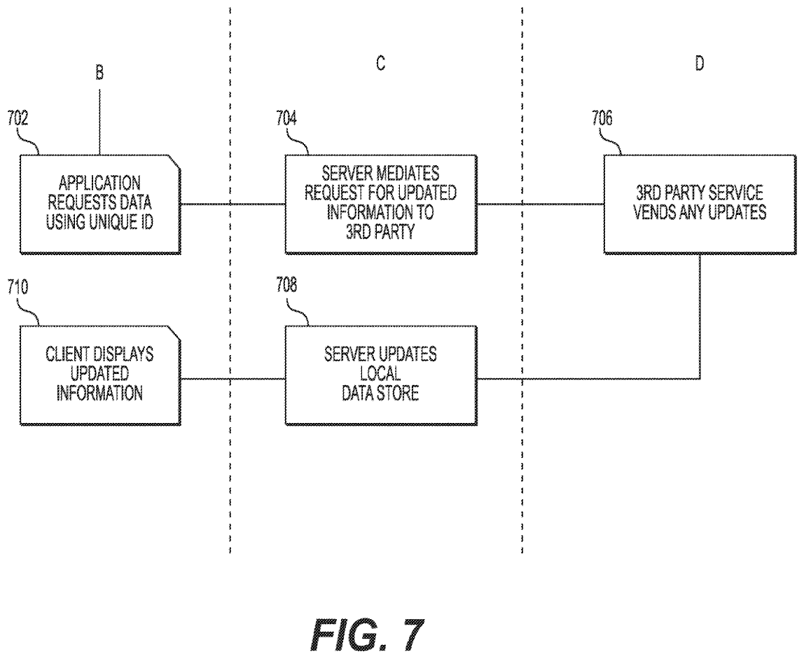

Illustrated in FIG. 7 is a diagram of a process for using financial data in accordance with an embodiment. With reference to FIG. 7, column B represents steps primarily associated with the client software application that runs on the information owner user device. Column C represents steps primarily associated with the service provider 120. Column D represents steps primarily associated with an external third party partner 140. Use of financial data may be performed at any time following the account registration process illustrated in FIGS. 4A-4C.

At step 702, an information owner 110 uses its unique ID to request financial information from the service provider 120. At step 704, the service provider 120 receives the request from the information owner 110 and requests the financial information from an appropriate external third party partner 140. At step 706, the external third party partner 140 receives the request from the service provider 120 and provides updated financial information to the service provider 120. At step 708, the service provider 120 receives and stores the updated financial information and sends the updated financial information to the information owner 110. At step 710, the updated financial information is received by the information owner 110 and displayed on the information owner user device.

As described above, an embodiment provides the benefit of decoupling personal identifying information from financial data, for purposes of securely obtaining information regarding financial products and services. Other embodiments may involve instances in which personally identifiable information is decoupled from other types of profile data. Such other types of profile data may include, for example, medical, insurance, web-browsing, shopping histories/activities, location, DNA, education, residential history, public services, public records, utilities, library, drivers licenses, marital status, deaths, births, land ownership, and vehicle ownership. Data can be shared based on permissions that are determined by information owners, those permissions defining which data may be accessed, which information consumers may access the data, and the duration for which the data may be accessed.

Embodiments may be used to maintain the security and confidentiality of consumer information in transactions involving transactions between individuals. As one example, residential applications in which information consumers (e.g., landlords) may evaluate an information owner's (e.g. tenant's) profile data for a limited time, thus reducing the landlords' potential liability for holding private tenant data. The service provider may track a tenant's residential history once the tenant has linked its banking and leasing information. The service provider may then retain the residential history information and allow the tenant to distribute the information at its discretion.

As another example, in the case of estate planning, an information owner (e.g., decedent) may selectively share account details with an information consumer (e.g., executor) so that the executor can manage and carry out financial actions in accordance with the decedent's will and as required by law. Prior to death, the decedent may utilize an embodiment to selectively share medical and financial information with family members at different stages of estate planning. For example, in early stages of planning, family members may simply be made aware of accounts while, after death, full account disclosure may be provided to ensure accounts are in good standing.

In the case of financial planning, an information owner may utilize an embodiment to obtain investment/goal planning proposals from information consumers based on the information owner's profile, prior to sharing its personally identifiable information. This ensures that proposals are based solely on relevant data points and non-discriminatory characteristics. In such cases, the service provider can, for example, enable financial advisors that are held to “Know Your Customer” compliance to obtain full access to all relevant profile data upon permissioning by the information owner.

In the case of medical services, once an information owner's identity has been established in accordance with an embodiment, the service provider can retain a medical profile unique to the information owner without potentially compromising personally identifiable information when evaluating the medical profile for services. The medical profile can remain associated with an information owner for a lifetime, and the medical profile can be easily accessed by information consumers in accordance with permissions defined by the information owner.

In the case of retail services, the service provider may receive customized offers of products or services based on the release of an information owner's profile information to information consumers (e.g., sellers) that they require to determine whether the offer can be made. The information required by sellers would need to be published to the service provider ahead of time, so that the information owner could determine whether it was willing to share that information. An information owner could review an offer and, upon acceptance, allow for personally identifiable information to be accessed by the seller. In this manner, an embodiment allows for information owners to avoid being inundated by sellers that are proposing products or services that are inapplicable to the information owner, or for which the information owner does not qualify.

In the case of verification services, the service provider can receive public services and works information associated with an information owner. The information could be shared and controlled for distribution by the information owner for use in verification and obtaining services based on a history of activity with public services. Over time, the service provider can retain historical financial information, which can be used to generate indicators of credit worthiness and financial fitness. By decoupling financial information from personally identifiable information, an embodiment may be used to generate profile and behavioral information for services to better understand information owners and to create solutions without putting personally identifiable information at risk.

In the case of insurance services, the service provider can store non-personally identifiable information of the type collected by insurance providers when preparing insurance quotes. Upon obtaining a satisfactory quote, an information owner may grant the insurance provider access to personally identifiable information, as well as non-personally identifiable information stored by the service provider, necessary to obtain an insurance policy based on the quote.

In the case of analytic data, the service provider can store non-personally identifiable information based on analytic data associated with an information owner, and the information owner can maintain control over how that analytic data is used in connection with personally identifiable data associated with the information owner.

It should be recognized that certain components or elements of the embodiments described above, or in the claims that follow, are numbered to allow ease of reference to them or to help distinguish between them, but order should not be implied from such numbering, unless such order is expressly recited. The above description and drawings are only to be considered illustrative of specific embodiments, which achieve the features and advantages described herein. Accordingly, the embodiments in this patent document are not considered as being limited by the foregoing description and drawings.

What is claimed is:

1. A method comprising the steps of:
performing an identification of an information owner;
storing a hash signature that can be used to subsequently verify the identity of the information owner, without storing personally identifiable information associated with the information owner in any form; and
providing verification of the identity of the information owner to an information consumer, using the stored hash signature and based on a permission defined by the information owner.

2. The method of claim 1 further comprising the step of storing non-personally identifiable information associated with the information owner.

3. The method of claim 2 further comprising the step of providing the non-personally identifiable information to an information consumer, based on permissions defined by the information owner.

4. The method of claim 2 further comprising the step of updating the non-personally identifiable information associated with the information owner.

5. The method of claim 1 further comprising the step of establishing a secure communication session between the information owner and the information consumer.

6. A method comprising the steps of:
receiving an indication from an information owner that the information owner has approved a grant request from an information consumer;
receiving, from the information consumer, a request to verify the identity of the information owner; and
verifying the identity of the information owner based on one or more hash signatures associated with the information owner without storing personally identifiable information associated with the information owner in any form.

7. The method of claim 6 further comprising the steps of:
receiving, from the information consumer, a request for non-personally identifiable information associated with the information owner; and
providing, to the information consumer, non-personally identifiable information associated with the information owner, based on permissions defined by the information owner.

8. A method comprising the steps of:
indicating, to a service provider, an intent to request access to information associated with an information owner;
receiving a key from the service provider;
requesting, from the information owner, access to information associated with the information owner; and
upon approval of the request by the information owner, receiving information associated with the information owner,
wherein the service provider does not store personally identifiable information associated with the information owner in any form.

9. The method of claim 8, wherein the received information associated with the information owner is non-personally identifiable information, and wherein the information is received from the service provider.

10. The method of claim 8, wherein the received information associated with the information owner is personally identifiable information, and wherein the information is received from the information owner.

11. A non-transitory computer-readable medium having instructions stored thereon that, when executed, cause a computer to perform the steps of:
receiving, from an information owner user device, an indication that an information owner has approved a grant request from an information consumer;
receiving, from an information consumer computer system, a request to verify the identity of the information owner; and
verifying the identity of the information owner based on one or more hash signatures associated with the information owner,
wherein the computer does not store personally identifiable information associated with the information owner in any form.

12. The non-transitory computer-readable medium of claim 11, having further instructions stored thereon that, when executed cause the computer to perform the steps of:
Receiving, from the information consumer computer system, a request for non-personally identifiable information associated with the information owner; and
providing to the information consumer non-personally identifiable information associated with the information owner, based on permissions defined by the information owner.

13. A non-transitory computer-readable medium having instructions stored thereon that, when executed, cause a computer to perform the steps of:
indicating to a service provider an intent to request access to information associated with an information owner;
receiving a key from a device associated with the service provider;
requesting from the information owner access to information associated with the information owner, and
receiving information associated with the information owner upon approval of the request by the information owner,
wherein the service provider does not store personally identifiable information associated with the information owner in any form.

14. The non-transitory computer-readable medium of claim 13, wherein the information associated with the information owner is non-personally identifiable information, and wherein the information associated with the information owner is received from a device associated with the service provider.

15. The non-transitory computer-readable medium of claim 13, wherein the information associated with the information owner is personally identifiable information, and wherein the information associated with the information owner is received from a device associated with the information owner.

16. A system comprising:
one or more hardware servers configured to store and process information;
wherein one or more servers are configured to facilitate direct communication between an information owner user device and an information consumer computer system;
wherein the one or more servers are configured to allow the information consumer computer system to access personally identifiable information and non-personally identifiable information associated with the information owner user device based on permissions defined by the information owner user device; and
wherein the one or more servers do not store personally identifiable information associated with the information owner user device in any form.

17. The system of claim 16, wherein the one or more servers are configured to identify blocks of personally identifiable information associated with the information owner user device via one or more hash signatures.

18. The system of claim 16, wherein the one or more servers are configured to communicate with an external computer system to update information associated with the information owner user device.

19. A non-transitory computer-readable medium having instructions stored thereon that, when executed, cause a computer to perform the steps of:
receiving contact information from an information owner;
creating a unique ID for the information owner;
creating a contact signature for the information owner;
establishing a communications oracle account, which is tied to the unique ID;
sending the unique ID, the contact signature, and session information to the information owner;
receiving a public key from the information owner;
storing the public key for use in establishing secure communications with the information owner;
sending a verification message with the unique ID to the communications oracle;
receiving identification information from the information owner;
relaying the identification to a third party partner for verification purposes;
receiving an ID conformation from the third party partner;
creating and storing an ID signature;
sending provisional identification information and signatures to the information owner;
receiving, from the information owner, consent to perform a data synchronization;
requesting a data synchronization;
receiving a credit report associated with the information owner;
storing the credit report, excluding any personally identifiable information associated with the information owner;
creating one or more ID signatures;
sending the one or more ID signatures to the information owner; and
permanently and irrevocably destroying all personally identifiable information associated with the information owner.

20. A non-transitory computer-readable medium having instructions stored thereon that, when executed, cause a computer to perform the steps of:
receiving, from an information consumer, an indication of an intent to send a grant request to an information owner;
issuing a unique key for the grant request to the information consumer;
presenting the information owner with the identity of the information consumer;
facilitating the initiation of a secure session between the information consumer and the information owner;
creating and storing a grant, the grant including a reference to a grant ID, to identifying information to be accessed, and to a duration of access;
supplying the information consumer with signatures associated with personally identifiable information that the information owner has sent to the information consumer;
receiving a request for access to non-personally identifiable information to which the information owner has granted access; and
providing the information consumer with information in accordance with permissions defined by the information owner.
